(19) United States
(12) Patent Application Publication
(10) Pub. No.: US 2004/0104963 A1
(43) Pub. Date: Jun. 3, 2004

(54) Image recording apparatus

(75) Inventor: Yusuke Nakazawa, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/721,262

(22) Filed: Nov. 26, 2003

(30) Foreign Application Priority Data
Nov. 29, 2002 (JP) 2002-348615

(51) Int. Cl. B41J 2/165

(52) U.S. Cl. 347/34

(57) ABSTRACT

In order to provide an image recording apparatus enabling to recover vapor of solvent efficiently, an image recording apparatus, which records an image on a recording medium, comprising in a housing thereof a water vapor removing section which removes water vapor, and a solvent recovering section which recovers vapor of organic solvent, which evaporates within the housing is provided.

### CROSS-REFERENCE TO RELATED APPLICATION

This application claims priority under 35 USC 119 from Japanese Patent Application No. 2002-348615, the disclosure of which is incorporated by reference herein.

### BACKGROUND OF THE INVENTION

1. Field of the Invention

The present invention relates to an image recording apparatus which records an image on an image recording medium.

2. Description of the Related Art

Color ink or black ink is widely used in an electrophotography apparatus or an ink jet type image recording apparatus, and organic solvent based ink is often used. Concretely, as the organic solvent based ink, ink for ink jet type image recording apparatus, electrophotography liquid developer or the like is used.

Organic solvent within ink is apt to evaporate, within a housing of an apparatus, to become vapor (steam). Therefore, a recovering device for recovering vapor of organic solvent is often provided within a housing of an image recording apparatus. Hereinafter, conventional technology, mainly, ink for ink jet type image recording apparatus, will be explained.

For example, it is disclosed in Japanese Patent Application Laid-Open (JP-A) No. 6-126945 that recovering means (a cooling element) for recovering solvent vapor is provided at a transfer-type ink jet type printer. The solvent vapor, which is generated when the solvent is removed from ink on a medium transfer body, is recovered, and the recovered solvent is discarded.

Further, in Japanese Patent Application Laid-Open (JP-A) No. 11-320856, ink solvent evaporating accelerating means is provided at a printer, solvent vapor generated from a recording paper is recovered, and the recovered solvent is recycled.

Recovering of the solvent vapor is carried out by absorbing it to an alumina or a silica, trapping it to a container in which liquid for cooling is accommodated, or the like. However, because a large quantity of water vapor is mixed in the vapor of the organic solvent within the housing, efficiency of recovering of the solvent vapor becomes low. Further, there arise problems such as scaling up of the recovering apparatus, increasing of electric power consumption of the recovering apparatus, lowering of maintenance ability, and the like.

### SUMMARY OF THE INVENTION

With considering the above mentioned problems, the present invention provides an image recording apparatus which can recover vapor of solvent efficiently and is miniaturized.

A first aspect of the present invention is an image recording apparatus which records an image on a recording medium, the image recording apparatus comprising in a housing thereof a water vapor removing section which removes water vapor, and a solvent recovering section which recovers vapor of organic solvent, which evaporates within the housing.

In a second aspect of the present invention according to the first aspect, the vapor of organic solvent is vapor evaporated from a recording liquid for recording the image on the recording medium.

In a third aspect of the present invention according to the third aspect, the water vapor removing section is provided at an inlet port which takes in air from outside of the housing into the inside of the housing.

In a fourth aspect of the present invention according to the third aspect, the solvent recovering section is provided at an outlet port which exhausts air from the inside of the housing to the outside of the housing.

In a fifth aspect of the present invention according to the fourth aspect, the housing is in a substantially sealed state except for the inlet port and the outlet port.

In a sixth aspect of the present invention according to the first aspect, an activated carbon filter is used as the water vapor removing section.

In a seventh aspect of the present invention according to the first aspect, a silica gel filter is used as the water vapor removing section.

In an eighth aspect of the present invention according to the first aspect, the image recording apparatus is an ink jet type image recording apparatus.

A ninth aspect of the present invention is an image recording apparatus which records an image on a recording medium, the image recording apparatus comprising in a housing thereof, a water vapor removing section which removes water vapor, and a solvent recovering section which recovers vapor of organic solvent, which evaporates within the housing, wherein the water vapor removing section is provided at an inlet port which takes in air from outside of the housing into the inside of the housing.

Here, water is not included in the concept of the organic solvent in the present invention. Further, the organic solvent is mainly volatile solvent in the present invention.

The water vapor is mixed to the vapor of organic solvent evaporating within the housing. Because the image recording apparatus comprises in the housing thereof the water vapor removing section which removes water vapor, the amount of this water vapor can be reduced to a large extent. Accordingly, effects such as that ability of the removing solvent of the solvent recovering section is improved; the solvent recovering section is stably operated (that is, maintenance performance is improved); the recovered organic solvent is reused, and the like are obtained. Further, it can be realized that the image recording apparatus is miniaturized.

Further, because the humidity within the housing is lowered considerably by the water vapor removing section, in a case in which a paper sheet is used as the image recording medium, waving of the paper sheet is prevented and dimension stability of the paper sheet is improved. Therefore, it can be prevented that jam occurs and it can be archived that high quality image is recorded. Further, in a case in which the recording medium is conveyed by used of electrostatic adsorption manner, adsorption force can be stabilized due to charging potential stabilization of the medium. Moreover, in a case of an ink jet image recording apparatus, electrostatic force applied to a ejected liquid droplet is maintained constantly because the charging potential is stabilized. Therefore, fly speed of the liquid droplet can be uniformed, and further high quality image can be obtained.

As the water vapor removing section, an adsorption filter (for example, an activated carbon filter), a cooling element (for example, Peltier element) or the like can be used, and any suitable members can be used.

The vapor of organic solvent is often the vapor evaporated from the recording liquid for recording the image on the recording medium. Accordingly, the amount of use of the organic solvent can be decreased drastically by recovering the solvent by the above mentioned solvent recovering section in a state in which the recovered organic solvent can be reused.

It is preferable that the water vapor in the air taken in the system of the image recording apparatus is removed by the water vapor removing section. For example, it is preferable that water vapor removing section is provided at the inlet port which inhales air outside of the housing to the inside of the housing. In this case, the humidity in the housing can be efficiently lowered because the all of air taken in the housing passes through the water vapor removing section.

As the above mentioned image recording apparatus, an electrophotography apparatus, an ink jet type image recording apparatus, or the like can used. Generally, liquid developer of organic solvent type is used in the electrophotography apparatus. Accordingly, the vapor of solvent within the housing can be efficiently recovered, and an electrophotography image of high quality can be obtained.

### BRIEF DESCRIPTION OF THE DRAWINGS

FIG. 1 is a side cross sectional view which shows structure of an ink jet type image recording apparatus of an embodiment of the present invention.

FIG. 2 is a partial perspective view which shows a head provided at the ink jet type image recording apparatus of the embodiment of the present invention. (An edge of a guard electrode at each ejection portion is not shown in this drawing in order for easy understanding.)

FIG. 3 is a side cross sectional view which shows a distribution of charged particles when many ejection portions of the head is used in the embodiment of the present invention (corresponding to an arrow indicated portion x-x in FIG. 2).

FIG. 4 is a side cross sectional view which shows a distribution of charged particles when a little ejection portions of the head is used in the embodiment of the present invention (corresponding to the arrow indicated portion x-x in FIG. 2).

FIG. 5 is a side cross sectional view which shows a distribution of charged particles when use of the image recording apparatus is stopped in the embodiment of the present invention (corresponding to the arrow indicated portion x-x in FIG. 2).

FIG. 6 is a side cross sectional view which shows a distribution of charged particles when many ejection portions of the head is used in the embodiment of the present invention (corresponding to the arrow indicated portion y-y in FIG. 2).

FIG. 7 is a partially enlarged side cross sectional view which shows an arrow indicated portion 7-7 in FIG. 6.

FIG. 8 is a plain cross sectional view which shows an arrow indicated portion 8-8 in FIG. 3 (an ink guide is shown without cut).

FIG. 9 is a plain cross sectional view which shows an arrow indicated portion 9-9 in FIG. 3 (an ink guide is shown without cut).

FIG. 10 is a plain cross sectional view which shows an arrow indicated portion 10-10 in FIG. 3 (an ink guide is shown without cut).

FIG. 11 is a partial perspective view which shows a modified example of the head provided at the ink jet type image recording apparatus of the embodiment of the present invention. (Edges of a guard electrode and a shield electrode at each ejection portion are not shown in this drawing in order for easy understanding.)

### DETAILED DESCRIPTION OF THE INVENTION

Hereinafter, referring to drawings, embodiments of the present invention, mainly, an ink jet type image recording apparatus will be described in detail. An example in which a solvent recovering section and a water vapor removing section are provided at an ink jet type image recording apparatus 22 (hereinafter, an image recording apparatus 22) will be explained. The ink jet type image recording apparatus 22 which is preferably used in the present invention is an image recording apparatus in which density of ink in the vicinity of an ink ejection portion is increased by electrophoresis of charged particles in an ink channel, and an ink droplet whose density is increased as such is ejected by electrostatic attraction force caused by mainly a recording medium or a counter electrode which is disposed at a back side of the recording medium.

An ink circulation system 24, a head unit 28 and a driver 32 are provided in a housing 28 of the image recording apparatus 22. The ink circulation system 24 circulates an ink. The head unit 28 has four heads (for four colors of Y, M, C and K, respectively) each of which ejects the corresponding ink provided from the ink circulation system 24. The driver is connected to the head unit 28.

At the housing 26, an air inlet (a suction port) 38 through which air at the outside of the housing 26 is taken in the housing 26 and an air outlet (an exhaust port) 40 through which air in the inside of the housing 26 is exhausted to the outside of the housing 26 are arranged. An exhausting section 42 is provided at the air outlet 40 at the inside of the housing 26. The exhausting section 42 exhausts an air within the housing 26 together with recovers solvent vapor contained in this air.

As a solvent recovering means of the exhausting section 42, one of means of the following well known methods (1)-(4) or the like can be singly used, or combination of means of the following well known means (1)-(4) or the like can be used.

(1) an adsorption method by use of an activated carbon, a silica gel, an activated alumina, an acid clay, a bentonite, a diatomaceous earth, a calcium carbonate, a titanium oxide, an adsorption form, or the like.

(2) a catalyzer method by use of a platinum, a vanadium, a rhodium, a titanium oxide, or the like.

(3) a cooling and concentration method by use of a peltier element, a compressor, a heat exchanging device, or the like.

(4) an electric collection method.

Especially, the cooling and concentration method and the electric collection method, by which the solvent can be recycled, are preferable.

An organic solvent based ink is used in the image recording apparatus 22. Mainly, the solvent vapor is vapor which evaporates from this ink. The housing 26 is in a state of sealing as far as possible without the air inlet 38 and the air outlet 40. That is, the housing 26 is substantially in a closed state. Therefore, due to exhaust from the exhausting section 42, air at the outside of the image recording apparatus 22 is sucked into the housing 22 only through the air inlet 38. Further, A water vapor removing section 44 is provided at the air inlet 38 at the inside of the housing 26. All air, which is sucked from the air inlet 38, at the outside the image recording apparatus 22 passes through the water vapor removing section 44.

[head]

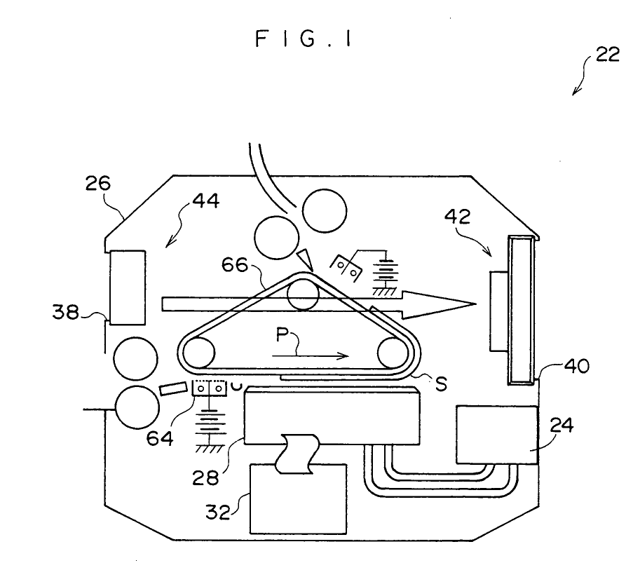

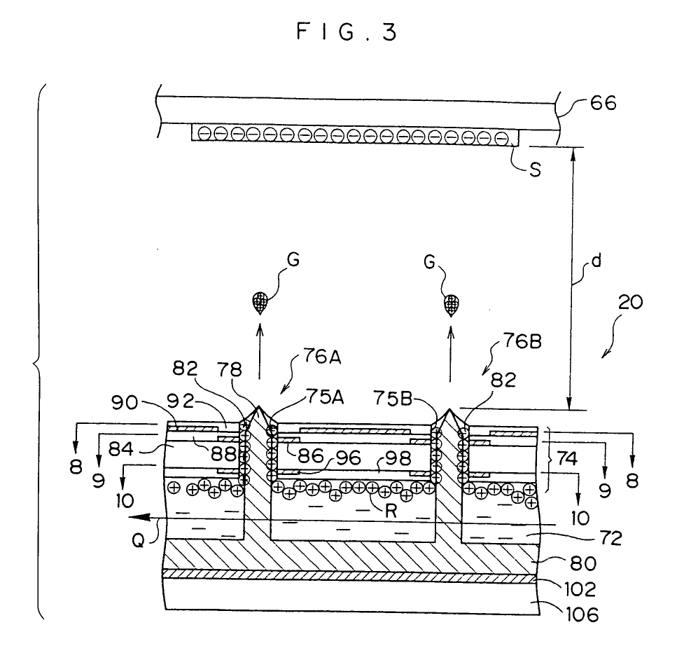

As shown in FIG. 1, a recording sheet S is held on a conveying member 66 in the image recording apparatus 22 such that the recording sheet S can be moved in a direction P. A head 20 is disposed below a position, at which the recording sheet S is in a substantially horizontal state, by a predetermined distance. The recording sheet S is charged negative (for example, −1.5 kV) by a Scorotron charger 64, therefore, the recording sheet S is electrostatically held at a lower side of the belt shape conveying member 66. A electrical insulating layer (not shown in the drawings) is provided at an outer side surface (in FIG. 3, at a lower side), on which the recording sheet S contacts, of the conveying member 66.

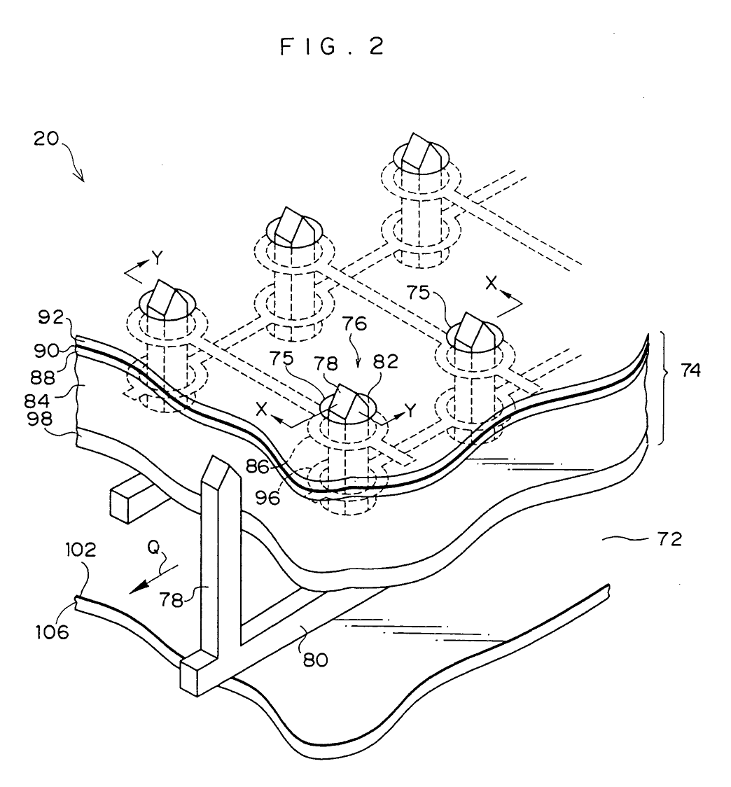

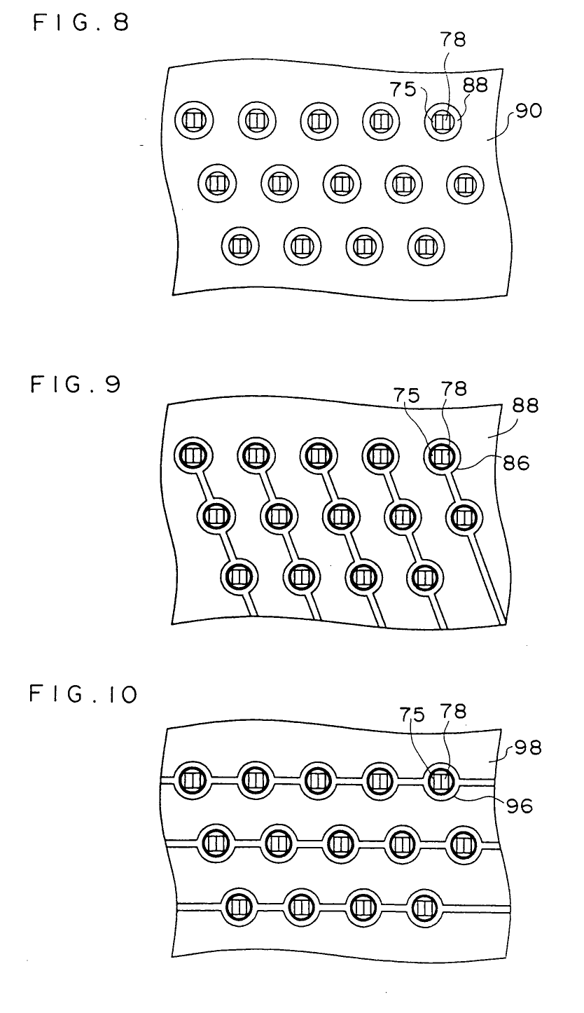

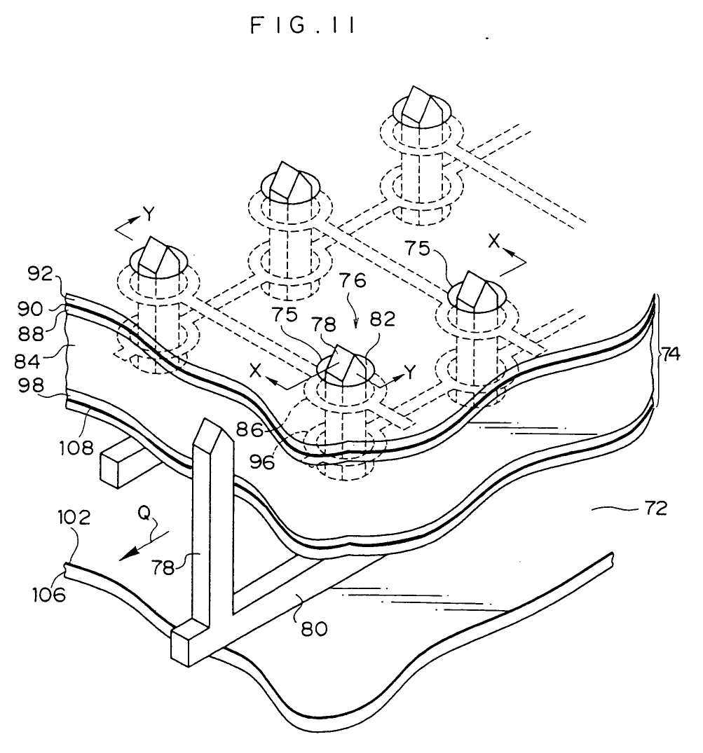

As shown in FIGS. 2 and 3, the head 20 has an ink channel 72, a substrate 74 and a plurality of ejection portions 76. The ink flows in one direction Q in the ink channel 72. The substrate 74 forms an upper wall of the ink channel 72. Each ejection portion 76 ejects the ink droplet toward the recording sheet S. An ink guide 78 is provided at each of the ink ejection portions 76. The ink guide 78 guides an ink droplet G, which flies from the ink channel 72, toward the recording sheet S. An opening 75 through which each ink guide 78 is inserted is formed in the substrate 74. An ink meniscus 82, at which the ink rises, is formed between the ink guide 78 and a inner wall surface of the opening 75 (see FIGS. 2, 3, 8, 9 and 10). A gap d between the ink guide 78 and the recording sheet S is often within a range between about 200 μm and about 1000 μm. Further, the ink guide 78 is fixed to a supporting bar member 80 at a lower end of the ink guide 78.

The substrate 74 has an insulating layer 84, a first ejection electrode 86, an insulating layer 88, a guard electrode 90, an insulating layer 92, a second ejection electrode 96 and an insulating layer 98. The insulating layer 84 separates two ejection electrodes by a predetermined distance to electrically isolate them from each other. The first ejection electrode 86 is formed at an upper side of the insulating layer 84. The insulating layer 88 covers the first ejection electrode 86. The guard electrode 90 is formed at an upper side of the insulating layer 88. The insulating layer 92 covers the guard electrode 90. The second ejection electrode 96 is formed at a lower side of the insulating layer 84. The insulating layer 98 covers the second ejection electrode 96. The guard electrode 90 is provided to prevent that electric field of the adjacent ejection portion is affected by voltage applied to the first ejection electrode 86 and the second ejection electrode 96.

Further, a floating conductive plate 102 is provided at the head 20. The floating conductive plate 102 forms a bottom surface of the ink channel 72. An ink particle (a charged particle) R charged positive in the ink channel 72 is migrated (so as to perform electrophoresis) upward (that is, toward the side of the recording sheet S) due to the floating conductive plate 102, by induced voltage generated steadily by ejection voltage in pulse state applied to the first ejection electrode 86 and the second ejection electrode 96. A coat layer (not shown in the drawings) which has electrical insulating characteristic is formed on a surface of the floating conductive plate 102, therefore, it is prevented that physical properties and/or component of the ink become unstable by injection of electric charge into the ink or the like. It is preferable that electrical resistance of the coat layer which has electrical insulating characteristic is equal to or more than 10¹² Ω·cm. It is further preferable that the electrical resistance is equal to or more than 10¹³ Ω·cm. Further, it is preferable that the coat layer which has electrical insulating characteristic is anticorrosive against the ink, as the result, it is prevented that the floating conductive plate 102 is corroded by the ink. Further, the floating conductive plate 102 is covered by an insulating member 106 at the bottom side of the floating conductive plate 102. Accordingly, the floating conductive plate 102 is completely in a state of electrically floating due to the structures mentioned above.

At least one floating conductive plate 102 is provided every one head. That is, in a case in which four heads for C, M, Y and K are provided at the image recording apparatus, each of the heads has at least one floating conductive plate, and there is no case in which a common floating conductive plate is used for the head for C and the head for M.

Colored charged particles whose diameter are about 0.1 μm-5 μm are dispersed in carrier liquid, and it is used as the ink provided in the ink channel 72. It is required that the carrier liquid is dielectric liquid having high specific resistance (resistivity) of 10¹⁰ Ω·cm or more. If the carrier liquid having low specific resistance is used, the electric charge is injected into the carrier liquid itself by voltage applied by the ejection electrode, as a result, the carrier liquid is charged. Therefore, in this case, it is impossible to increase density of the charged particles (charged ink particles), that is, concentration of the charged particles does not occur. Further, use of the carrier liquid of low specific resistance is not appropriate to the present embodiment because it is concerned that the carrier liquid of low specific resistance causes electrical breakdown between the adjacent recording electrodes.

It is preferable that specific dielectric constant of the dielectric liquid is equal to or less than 5, more preferably, equal to or less than 4, further preferably, equal to or less than 3.5. Electric field is applied to the charged particles in the dielectric liquid effectively by setting the specific dielectric constant at a value within the range mentioned above. As a result, the electrophoresis becomes likely to occur.

Straight chain or branch aliphatic hydrocarbons, alicyclic hydrocarbon, aromatic hydrocarbon, halogen substitution product of these hydrocarbons and the like are preferable as the dielectric liquid used in the present invention. For example, one of the following is singly used, or mixture of some of the following is used: hexane, heptane, octane, isooctane, decane, isodecane, dekalin, nonane, dodecane, isododecane, cyclohexane, cyclooctane, cyclodecane, benzen, toluene, xylene, mesitylene, Isopar C, Isopar E, Isopar G, Isopar H, Isopar L (Isopar (trade name): Exxon Corporation), Shellsol 70, Shellsol 71 (Shellsol (trade name) Shell Oil Corporation), Amusco OMS Amusco 460 (Amusco (trade name): Spirits Co., Ltd.), Silicon Oil (for example, KF-96L manufactured by Shin-etsu Chemical Co., Ltd.)

Regarding the color particles dispersed in the nonaqueous solvent mentioned above, it is possible that coloring material itself as dispersed particle is dispersed in the dielectric liquid, or it is possible that the coloring material is contained in dispersed resin particle for improvement of fixing. In a case in which the coloring material is contained in dispersed resin particle, in a case of pigment or the like, it is a general method in which the pigment is coated by resin material of the dispersed resin particles to make a resin coated particle. In a case of dye or the like, it is a general method in which dispersed resin particle is dyed (colored) to generate color particle. As the color material, any one of ink composition for ink-jet, ink composition for printing, or the pigment or the dye which is used in liquid developer for electrophotography can be used. It is preferable that these color particles are contained within a range of 0.5-30 percentage by weight with respect to the total of the ink. It is further preferable that the range is between 1.5-25 percentage by weight, more preferably, the range is between 3.0-20 percentage by weight.

It is preferable that an average particle diameter of the color particles dispersed in the dielectric solvent of the present invention is within a range of 0.1 μm-5 μm, more preferably, 0.2 μm-1.5 μm, further preferably, 0.4 μm-1.0 μm. The particle diameter is measured by CAPA-500 (trade name) manufactured by HORIBA, Ltd.

Regarding the ink composition, it is preferable that viscosity is within a range of 0.5 mPa·sec·5 mPa·sec, more preferably, 0.6 mPa·sec−3.0 mPa·sec, further preferably, 0.7 mPa·sec−2.0 mPa·sec. The color particle has charge, and various charge control agent used in the liquid developer for electrophotography can be used according to demand. In this case, it is preferable that charge amount is within a range of 5 μC/g-200 μC/g, more preferably, 10 μC/g-150 μC/g, further preferably, 15 μC/g-100 μC/g. It may occur that electrical resistance of the dielectric solvent is changed by addition of the charge control agent. It is preferable that the distribution factor P defined below is equal to or more than 50%, more preferably, equal to or more than 60%, further preferably, equal to or more than 70%.

P=100×(σ1−σ2)/σ1

In this mathematical expression, σ1 is electric conductivity of the ink composition, σ2 is electric conductivity of supernatant liquid which is obtained by the ink composition is subject to centrifugation by a centrifugal separator. Values of the electric conductivity are measured, by use of a LCR meter (AG-4311 manufactured by Ando Electric Co., Ltd.) and an electrode for liquid (LP-05 type manufactured by Kawaguchi Electric Works Co., Ltd.), in a condition in which applied voltage is 5 V and frequency is 1 kHz. Further, the centrifugation is carried out in 30 minutes by use of a small high speed cooling centrifugal separator (SRX-201 type manufactured by TOMY SEIKO CO., LTD.) in a condition in which rotation speed is 14500 rpm and temperature is 23° C.

By use of the ink whose composition is such mentioned above, the electrophoresis of the charged particles becomes likely to occur. Further, the concentration of the charged particles becomes likely to occur.

It is preferable that the electric conductivity of the ink composition σ1 is within a range of 100 pS/cm-3000 pS/cm, more preferably, 150 pS/cm-2500 pS/cm, further preferably, 200 pS/cm-2000 pS/cm. By setting the electric conductivity of the ink composition σ1 within the range mentioned above, voltage applied to the ejection electrode does not become extremely high, therefore, it is not feared that electrical breakdown between the adjacent recording electrodes occurs. Further, it is preferable that surface tension of the ink composition is within a range of 15 mN/m-50 mN/m, more preferably, 15.5 mN/m-45 mN/m, further preferably, 16 mN/m-40 mN/m. By setting the surface tension of the ink composition within the range mentioned above, voltage applied to the ejection electrode does not become extremely high, therefore, it is prevented that the ink leaks from the head, spread, and the head is contaminated.

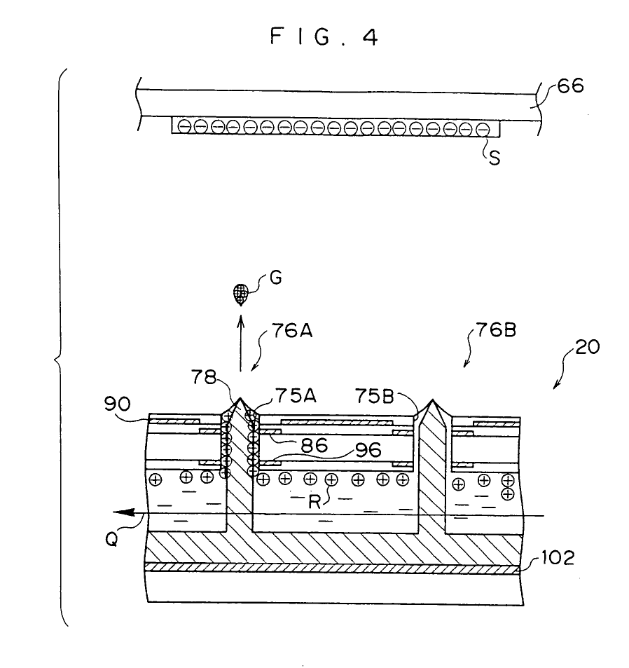

As shown in FIGS. 3 and 4, in order to cause the ink to fly from the head 20 such that the recording sheet S is recorded, a predetermined positive voltage (for example, +100 V) is applied to the guard electrode 90 in a state in which the ink flow Q is generated by circulating the ink within the ink channel 72.

Further, voltage is applied to the first ejection electrode 86 and the second ejection electrode 96 such that flight-electric field is formed between the first ejection electrode 86 and the second ejection electrode 96 and the recording sheet S, the flight electric field being an electric field by which the positive charged particles R within the ink droplet G, which is guided by means of the ink guide 78 and flies from the opening 75, is attracted to and arrive at the recording sheet S. For example, as a temporary standard, electric potential difference of about 1 kV-3 kV is formed in a case in which the gap d is 500 μm.

In this state, when the pulse voltage is applied to the first ejection electrode 86 and the second ejection electrode 96 in accordance with the image signals, the ink droplet G whose charged particle density is made high is ejected from the opening 75. For example, in a case in which the initial charged particle density is within a range of 3%-15%, the charged particle density of the ink droplet G becomes equal to or more than 30%.

In this case, the electric field between the first ejection electrode 86 and the second ejection electrode 96 is adjusted such that the ink droplet G is ejected only when the pulse voltage is applied to both the first ejection electrode 86 and the second ejection electrode 96. As a result, matrix driving becomes possible, therefore, the number of drivers can be reduced. That is, attraction electric field toward the recording medium is set within a range of equal to or less than 1.5×10⁷ V/m, preferably, equal to or less than 1.0×10⁷ V/m in a state in which the ink droplet G is not ejected, and the electric field toward the recording medium is set within a range of equal to or more than 2.0×10⁷ V/m, preferably, equal to or more than 2.5×10⁷ V/m in a state in which the ink droplet G is ejected. For example, in a case in which a space between the first ejection electrode 86 and the second ejection electrode 96 is 50 μm, the pulse voltage of +600 V is applied to both the first ejection electrode 86 and the second ejection electrode 96. Pulse width is often within a range from several tens μs to several hundreds μs. A diameter of a dot recorded on the recording sheet depends on the pulse voltage and application time of the pulse voltage and can be adjusted.

When the pulse positive voltage is applied as such, the ink droplet G is guided by means of the ink guide 78, flies from the opening 75 and is adhered to the recording sheet S. Together with this, the positive induced voltage is generated in the floating conductive plate 102 due to the positive voltage applied to the first ejection electrode 86 and the second ejection electrode 96. Even in the case in which the voltage applied to the first ejection electrode 86 and the second ejection electrode 96 is pulse voltage, the induced voltage is substantially constant. (For example, in a case in which the pulse voltage in which 600 V and 0 V repeat alternately is applied to the first ejection electrode 86 and the second ejection electrode 96, the positive voltage of 300 V is generated in the floating conductive plate 102 constantly. It is preferable that the electric potential difference of several hundreds V is set with respect to thickness in vertical direction of the ink channel 72 of several μm. Accordingly, due to the positive electric potential of the floating conductive plate 102, the charged particle R which is charged positive in the ink channel 72 receives force which moves the charged particle R upward, therefore, the density of the charged particles R in the vicinity of the substrate becomes high. At this time, even though the ink is located in the opening 75, it may occur that the charged particle R in the opening is constrained by surface tension of the ink, as a result, the density of the charged particles R becomes high. That is, the concentration is further proceeded due to choice of voltage application condition and the physical properties of the ink.

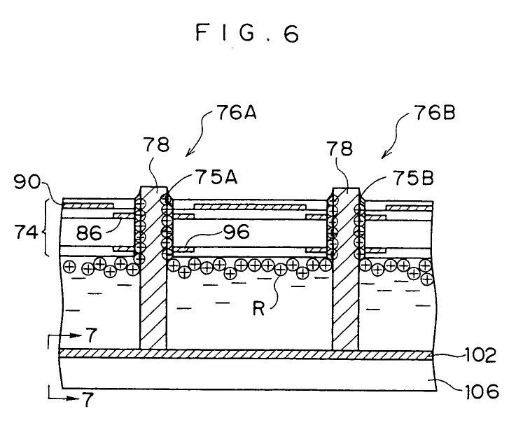

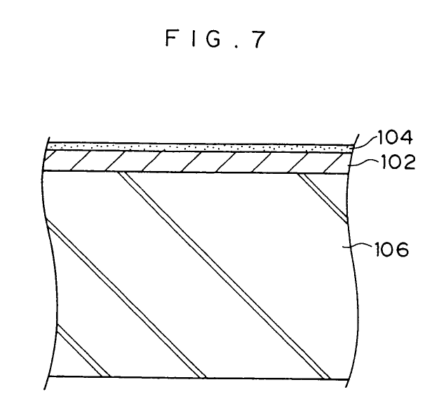

As shown in FIGS. 3 and 6, in a case in which the ejection portions in use (the channels ejecting the ink droplets) are large in number, because the first ejection electrodes 86 and the second ejection electrodes 96 in use are large in number, voltage which is induced at the floating conductive plate 102 becomes high. Therefore, the number of the charged particles R which move to the recording sheet side increases.

As shown in FIG. 4, in a case in which the ejection portions in use are small in number, because the first ejection electrodes 86 and the second ejection electrodes 96 in use are small in number, voltage which is induced at the floating conductive plate 102 becomes low. Therefore, the number of the charged particles R which move to the recording sheet side decreases relatively. Therefore, the density at the upper portion of the ink channel does not become so high. As a result, even in a case in which the ejection portions in use are small in number, it can be prevented that the opening 75B of the ejection portion 76B not in use (the channel not ejecting the ink droplet) is clogged. Together with this, the density of the ink droplet G which is fried from the vicinity of the opening 75A of the ejection portion 76A in use (the channel ejecting the ink droplet G) can be made high moderately.

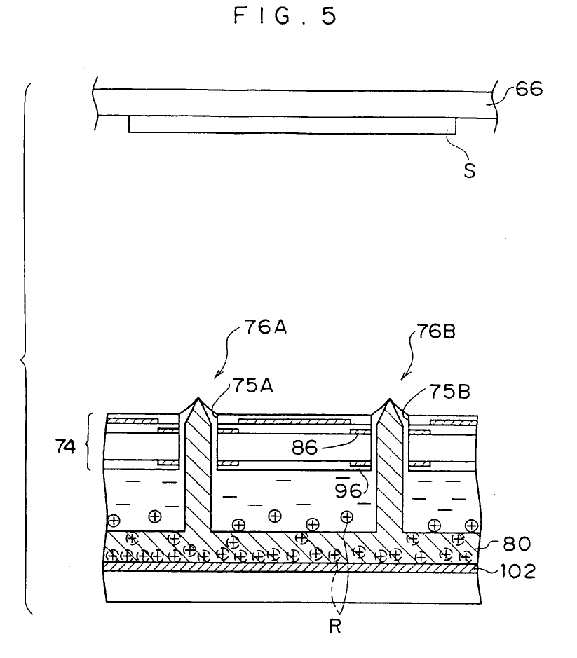

Further, because negative charging for the recording sheet by the Scorotron charger 64 is not carried out at a time in which operation of the image recording apparatus 22 (refer to FIG. 1) is stopped, as shown in FIG. 5, constant positive voltage is applied at least one of the first ejection electrode 86 and the second ejection electrode 96 in this state. As a result, the charged particle R is moved toward the floating conductive plate 102 due to the electric field generated between the ejection electrodes and the floating conductive plate 102, the density of the charged particles R in the vicinity of the substrate 74 in the ink channel becomes low. That is, the opening 75 is self cleaned. It is possible that a switch (not shown in the drawings), which enables to switch between a state of floating and a state of application of negative voltage for self cleaning, is connected to the floating conductive plate 102, to set the floating conductive plate 102 in electrical floating state at a time of operation of the image recording apparatus 22 and to apply negative voltage to the floating conductive plate 102 at a time of stop of operation of the image recording apparatus 22.

Thus, in the present embodiment, the floating conductive plate 102 is electrical floating state, that is, electrical insulation state. As a result, the density of the charged particles R in the vicinity of the substrate 74 is high in a case in which the ejection portions in use (that is, the ejection electrodes in use) are many in number, and the density of the charged particles R in the vicinity of the substrate 74 is low in a case in which the ejection portions in use are a little in number. Namely, the density is automatically adjusted. Accordingly, it is prevented that the openings of the ejection portions not in use are clogged even in a case in which the ejection portions in use are small in number. Further, a case in which the ink particle is a positive charged particle has been explained above, however, the ink particle may have the reverse polarity (that is, the ink particle is a negative charged particle). In this case, the recording medium has also the reverse polarity.

It has been explained that the positive charged particle is used, the positive voltage is applied to the ejection electrode, and the recording medium is negatively charged. However, it is possible that polarity of the charged particle is the same as that of the voltage applied to the ejection electrode when the ink is ejected, and electro static charge polarity of the recording medium is the same as the polarity of the charged particle, or the recording medium is not charged. Further, it is possible that polarity of the charged particle is inverse to that of the voltage applied to the ejection electrode when the ink is ejected and charge polarity of the recording medium.

Further, because an electrostatic force is not applied to the whole of the ink but is applied to the charged particles (charged ink particles) R, which are solid bodies dispersed in the carrier liquid, an image can be recorded on various recording medium such as a plain paper, a nonabsorbable PET film and the like. Further, loss of definition or blur on the recording medium does not occur. Therefore, a high quality image can be formed on the various image recording medium.

As shown in FIG. 11, structure, in which a shield electrode 108 is provided within the insulating layer 98 and the electric potential which moves the charged particle R toward the recording sheet side can be applied to the floating conductive plate 102, can be applied to the image recording apparatus. In this case, it is prevented that the charged particle R receives repulsive (repellent) force from the ejection portion 76 by the electric potential due to the first ejection electrode 86 and the second ejection electrode 96.

As described above, in the present embodiment, the exhausting section 42 is provided at the air outlet 40, and the water vapor removing section 44 is provided at the air inlet 38 at the inside thereof. Because all air outside the image recording apparatus 22, which is sucked from the air inlet 38, pass through the water vapor removing section 44, the humidity within the housing 26 can be lowered drastically. As a result, amount of water vapor recovered by the exhausting section 42 decreases drastically. Therefore, the electric power consumed by the exhausting section 42 decreases very much, that is, energy saving is archived. Further, the exhausting section 42 can be miniaturized. Moreover, waving and jamming of the recording sheet S can be prevented, and a high quality image can be recorded on the recording sheet S.

### EXAMPLE 1

Heads of 1200 dpi/1200 ch, each having the structure shown in FIG. 2, are installed in the image recording apparatus 22 shown in FIG. 1. Each of the heads correspond to respective colors (one head corresponds to none color). Further, an activated carbon filter is used as the water vapor removing section. As a cooling and concentration device of the solvent recovering device, a well known device comprising a cooling device and a mist separator is used. the cooling device comprises a plurality of cooling fins made of aluminum and a refrigerant pipe passing through the cooling fins. A refrigerant delivery pipe and a refrigerant return pipe from a cooler unit are connected to the refrigerant pipe for circulation of refrigerant. Temperature of the refrigerant is −10° C. The mist separator disposed at downstream side of the cooling device is formed from a stainless mesh member. The mist separator recovers solvent mist, which is atomized within the cooling device, by liquefcation manner. Further, it is possible that gas obtained by solvent-removing by the cooling and concentration device is returned to the device inside such that the gas is circulated in this cooling and concentration device in a plurality of times. The recovered solvent is recycled as an ink diluted solution. In a case in which ink containing solvent Isopar G is used, solvent contents of the exhaust gas (gas exhausted outside the device) is 23 ppm, and it does not smell. Further, degradation of efficiency by icing of moisture contained in air within the cooling and concentration element does not occur.

### EXAMPLE 2

A silica gel is used as the water vapor removing section. Further, the structure of the solvent recovering device is altered. Other structures as those of the Example 1 are the same. At the solvent recovering device, temperature of the cooling device is −5° C., and an absorption filter is further provided at the downstream side. The absorption filter has a structure in which honeycomb layer formed of an activated carbon fiber (height: 10 cm, length: 30 cm, thickness: 6 cm) is attached to a cartridge. In a case in which ink containing silicon oil (KF-96-1CS manufactured by Shin-etsu chemical Co., Ltd.) as solvent is used, solvent contents of the exhaust gas (gas exhausted outside the device) is 18 ppm, and at the vicinity of the gas exhaust portion, it is not soiled and sticky at all. Further, degradation of efficiency by icing of moisture contained in air within the cooling and concentration element does not occur.

The embodiments and the examples of the present invention are explained above. However, those embodiments and the examples are examples, and it will be appreciated that numerous changes and modifications are likely to occur, and it is intended to cover all changes and modifications which fall within the scope of the invention. Further, the scope of the present invention is not limited to the embodiments and the examples described above.

Because the image recording apparatus has the structure mentioned above, the image recording apparatus which can recover vapor of organic solvent efficiently and is miniaturized can be realized.

What is claimed is:

1. An image recording apparatus which records an image on a recording medium, the image recording apparatus comprising in a housing thereof:
a water vapor removing section which removes water vapor; and
a solvent recovering section which recovers vapor of organic solvent, which evaporates within the housing.

2. An image recording apparatus according to claim 1, wherein the vapor of organic solvent is vapor evaporated from a recording liquid for recording the image on the recording medium.

3. An image recording apparatus according to claim 1, wherein the water vapor removing section is provided at an inlet port which takes in air from outside of the housing into the inside of the housing.

4. An image recording apparatus according to claim 3, wherein the solvent recovering section is provided at an outlet port which exhausts air from the inside of the housing to the outside of the housing.

5. An image recording apparatus according to claim 4, wherein the housing is in a substantially sealed state except for the inlet port and the outlet port.

6. An image recording apparatus according to claim 1, wherein an activated carbon filter is used as the water vapor removing section.

7. An image recording apparatus according to claim 1, wherein a silica gel filter is used as the water vapor removing section.

8. An image recording apparatus according to claim 1, wherein the image recording apparatus is an ink jet type image recording apparatus.
